(19) United States
(12) Patent Application Publication
(10) Pub. No.: US 2024/0177076 A1
(43) Pub. Date: May 30, 2024

(54) DIGITAL TWIN FOR GREEN AMMONIA FACILITY USING A LOW CARBON ENERGY SOURCE AND RELATED METHODS OF USE

(71) Applicants: Zhentao Feng, Sugar Land, TX (US); Satish Bantwal Baliga, Katy, TX (US); Ekaterini Yamalidou, Houston, TX (US); Paolo Brunengo, Woking (GB); Rafal Bernat, Leatherhead Surrey (GB)

(72) Inventors: Zhentao Feng, Sugar Land, TX (US); Satish Bantwal Baliga, Katy, TX (US); Ekaterini Yamalidou, Houston, TX (US); Paolo Brunengo, Woking (GB); Rafal Bernat, Leatherhead Surrey (GB)

(73) Assignee: KELLOGG BROWN & ROOT LLC, Houston, TX (US)

(21) Appl. No.: 18/513,335

(22) Filed: Nov. 17, 2023

Related U.S. Application Data
(60) Provisional application No. 63/428,013, filed on Nov. 25, 2022.

(51) Int. Cl. G06Q 10/04; G06Q 50/06

(52) U.S. Cl. CPC G06Q 10/04; G06Q 50/06

(57) ABSTRACT

A method of evaluating one or more aspects of a low carbon ammonia production facility uses a digital twin implemented on a computer system. The digital twin includes a low carbon energy source component and one or more of: a hydrogen source component, a nitrogen source component, and an ammonia synthesis loop component.

### CROSS REFERENCE TO RELATED APPLICATIONS

This application claims the benefit of U.S. Provisional Patent Application No. 63/428,013, filed on Nov. 25, 2022, which is hereby incorporated by reference for all purposes as if fully set forth herein.

### TECHNICAL FIELD

The present disclosure relates to producing ammonia using a low carbon energy source.

### BACKGROUND

Conventionally, ammonia is produced by reacting hydrogen with nitrogen in the presence of a catalyst. A hydrocarbon feedstock is typically used to generate the hydrogen feed for the ammonia production process. Proposals to eliminate the hydrocarbon feedstock and decarbonize ammonia production sometimes employ alternative hydrogen production methods such as electrolysis, which only requires water and electricity. If a renewable energy source supplies the electricity for the electrolysis, then hydrogen for ammonia production can be generated without carbon emissions. The present disclosure addresses the need for efficient low carbon ammonia production while utilizing renewable energy sources.

### SUMMARY

Exemplary examples are provided of a digital twin for low carbon ammonia production facility and related methods of use thereof that can substantially obviate one or more of the problems of the related art.

In aspects, the present disclosure provides a method of evaluating one or more aspects of a low carbon ammonia production facility. The method may include the steps of: providing a digital twin implemented on a computer system that includes a processor and non-transitory memory running software stored in a non-transitory memory; entering at least one input into the computer system; and obtaining at least one output using the digital twin and the at least one available input. The digital twin may include at least: a component representing a hydrogen source generated at least partly with low carbon energy, a component representing a nitrogen source, and a component representing an ammonia synthesis loop.

In examples, provided is a method of evaluating one or more aspects of a low carbon ammonia production facility. In examples, the method may include providing a digital twin implemented on a computer system that includes a processor and non-transitory memory running software stored in a non-transitory memory. The digital twin may include a hydrogen source component; a nitrogen source component; and an ammonia synthesis loop component. The method may further include receiving by the digital twin at least one input that may include facility-specific information, non-facility specific information, or other information; and simulating the low carbon ammonia production facility via the digital twin to generate at least one simulated facility output based on the at least one input.

In examples, the low carbon ammonia production facility may include a low carbon energy source and the at least one input received by the digital twin may include a forecasted energy availability profile for a low carbon energy source over a period of time.

In examples, the digital twin may include a secondary energy source component. In examples, the digital twin may include a secondary hydrogen source component.

In examples, the method may include receiving additional inputs at time intervals, and iteratively simulating the low carbon ammonia production facility via the digital twin based on the additional inputs to obtain the at least one simulated facility output for each time interval.

In examples, the method may include receiving additional forecasted energy availability profiles for the low carbon energy source at sequential time intervals; and iteratively simulating the low carbon ammonia production facility via the digital twin based on the additional forecasted energy availability profiles to obtain the at least one simulated facility output for each time interval.

In examples, the at least one simulated facility output may be obtained based on one or more predetermined targets. In examples, the one or more predetermined targets may include a target cumulative production, target of stable operation of the ammonia synthesis loop that is part of the low carbon ammonia production facility, target of low carbon energy requirement, or any combination thereof.

In examples, provided is a method of managing the design and/or operation of a low carbon ammonia production facility. The method may include providing a digital twin implemented on a computer system that includes a processor and non-transitory memory running software stored in a non-transitory memory. The digital twin may include a hydrogen source component; a nitrogen source component; and an ammonia synthesis loop component. In examples, the method may include receiving by the digital twin an input that may include facility-specific information, non-facility specific information, or other information; and simulating the low carbon ammonia production facility via the digital twin to generate at least one simulated facility output based on the at least one input.

In examples, the method may include revising a facility plant design, a design of one or more facility equipment, one or more operating conditions, an operational plan of the low carbon ammonia facility, or any combination thereof, based on the at least one simulated facility output generated by the digital twin.

In examples, the receiving, by the digital twin, of an input may include receiving an input from a user, and further may include evaluating the user input based on the at least one simulated facility output.

In examples, the method may include receiving, by the digital twin, additional inputs at time intervals, and iteratively simulating the low carbon ammonia production facility via the digital twin based on the additional inputs to obtain the at least one simulated facility output for each time interval.

In examples, provided is a method for producing ammonia using a low carbon energy source, the ammonia being produced by a facility having an ammonia synthesis loop, the method including supplying energy to the facility, wherein at least a portion of the supplied energy may be from a low carbon energy source; receiving a forecasted energy availability profile for the low carbon energy source over a time period; simulating, using digital twin, the operation of the facility based on the forecasted energy availability profile for the low carbon energy source; defining, by the digital twin, the design and operational aspects of the low carbon ammonia production facility.

In examples, provided is a method for producing ammonia in a low carbon ammonia production facility having an ammonia synthesis loop. The method may include supplying energy to the facility from a low carbon energy source; providing a digital twin that may include one or more software components configured to simulate one or more elements or parts of the low carbon ammonia production facility; receiving, by a digital twin, a forecasted energy availability profile for the low carbon energy source over a time period; simulating, using a digital twin, an operation of the facility based on the forecasted energy availability profile for the low carbon energy source to generate one or more simulated facility outputs; and defining, based on the one or more simulated facility outputs, one or more of a design and operational aspects of the low carbon ammonia production facility.

In examples, the method may include receiving, by the digital twin, additional forecasted energy availability profiles for the low carbon energy source at time intervals; iteratively simulating the operation of the facility via the digital twin based on the additional forecasted energy availability profiles to generate one or more additional simulated facility outputs for each time interval; and revising, based on the one or more additional simulated facility outputs, one or more of the design and operational aspects of the low carbon ammonia production facility at each time interval.

In examples, the method may include generating a hydrogen feed and also may include using a hydrogen feed provided from: (i) a hydrogen storage unit (ii) a secondary hydrogen source importing hydrogen into the facility, for example through a pipeline, or (iii) a combination of (i) and (ii).

In examples, the digital twin may operate using facility-specific information and non-facility-specific information, the non-facility-specific information including the forecasted energy availability profile for the low carbon energy source over a time period.

In examples, the non-facility-specific information may include availability of energy from a secondary energy source, and the method may include transferring energy between the facility and the secondary energy source. In examples, the transferring may include (i) exporting energy from the low carbon energy source to the secondary energy source, and/or (ii) importing energy from the secondary energy source to the facility.

In aspects, the present disclosure provides a computer program product that includes a non-transitory memory storing computer-executable code that, when executed by a processor, causes the processor to: construct the digital twin of a low carbon ammonia production facility and use it to simulate the operation of the modelled low carbon ammonia production facility; receive at least one input; and generate at least one output using the digital twin and the at least one available input.

In examples, provided is a computer program product that may include a non-transitory memory storing computer-executable code that, when executed by a processor, causes the processor to: generate a digital twin of a low carbon ammonia production facility; receive by the digital twin an input including facility-specific information, non-facility specific information, or other information; and simulate a low carbon ammonia production facility via the digital twin to generate at least one simulated facility output based on the at least one input.

In examples, the digital twin may include a hydrogen source component, a nitrogen source component, an ammonia synthesis loop component, or a combination thereof. In examples, the digital twin may include a secondary energy source component, a secondary hydrogen source component, or both.

In examples, the computer-executable code, when executed by a processor, may cause the processor to receive by the digital twin, additional inputs including facility-specific information, non-facility specific information, or other information at time intervals; and iteratively simulate the low carbon ammonia production facility via the digital twin based on the additional inputs to obtain the at least one simulated facility output for each time interval.

In examples, each input received by the digital twin may include a forecasted energy availability profile for a low carbon energy source over a period of time.

In examples, the at least one simulated facility output may be obtained based on the at least one input and on one or more predetermined targets.

It should be understood that certain features of the disclosure have been summarized rather broadly in order that the detailed description thereof that follows may be better understood, and in order that the contributions to the art may be appreciated. There are, of course, additional features of the disclosure that will be described hereinafter and which will in some cases form the subject of the claims appended thereto.

### BRIEF DESCRIPTION OF THE DRAWINGS

For detailed understanding of the present disclosure, references should be made to the following detailed description taken in conjunction with the accompanying drawings, in which like elements have been given like numerals and wherein:

FIG. 1 schematically illustrates a low carbon process for synthesizing ammonia using a low carbon energy source in accordance with one example of the present disclosure;

FIG. 2 diagrammatically illustrates a digital twin in accordance with one example of the present disclosure configured to model and simulate an ammonia production facility that uses a low carbon energy source (hereafter “facility 100”);

FIG. 3 diagrammatically illustrates the inputs and outputs for the FIG. 2 digital twin; and

FIGS. 4-6 are flow charts illustrating uses of a digital twin in accordance with the present disclosure.

### DETAILED DESCRIPTION

In aspects, the present disclosure is directed to constructing and using a digital twin of a facility configured and designed to synthesize ammonia using low carbon processes.

In examples, a digital twin as described herein may include a simulation model that virtually replicates one or more elements, portions, or sections of the facility configured and designed to produce ammonia using a low carbon energy source. The facility may physically exist or may exist as a design. The digital twin may be based on a combination of one or more first-principles process models, empirical correlations and data-driven models, and incorporates the topology of low carbon ammonia production facility, equipment design details, equipment performance characteristics, catalyst performance information, the steady state and dynamic response of all processes, equipment and storage units of the facility, and the actual operational constraints of the facility. In some examples the digital twin may be based on data driven methods or a combination of data driven methods and first-principles process models.

In examples, the digital twin as described herein may be an accurate representation of the topology of a low carbon ammonia production facility with respect to the type and size of all equipment of the facility, the steady state and dynamic response of all processes of facility, and/or the actual operational constraints of the facility. The digital twin may have embedded first principles models, empirical correlations, and/or data-driven models, accurately representing the structure, behavior and operation of facility. The digital twin may use facility specific and/or non-facility specific information to perform calculations. The digital twin may display the output of calculation to facilitate the decision-making process during design or operation of the facility.

A facility producing ammonia using energy from low carbon sources (referred to herein as “low carbon ammonia production facility”) can be thought of as having two parts, the front end and the back end. The front end may refer to the portion of the facility that includes the hydrogen production unit that uses a method based on low carbon energy source to produce hydrogen. The back end may refer to the portion of the facility that includes the ammonia synthesis loop that uses hydrogen and nitrogen to produce ammonia.

At the front end, the rate of energy from low carbon sources, such as wind and solar, may be unstable in nature and its availability may fluctuate over time. This may result in variability of hydrogen production. Renewable energy sources, such as wind or solar power, are prone to changes in environmental conditions; e.g., lulls in winds, inclement weather, etc. A reduction in wind speed or sunlight intensity can lead to reductions in available electrical power. Reduced electrical power, in turn, causes the primary hydrogen production source (e.g., an electrolyzer) to generate less hydrogen feed.

On the other hand, the back end of ammonia production requires a stable feedstock of hydrogen. Efficient ammonia production requires steady-state conditions such as invariant flowrate for the hydrogen feed. A decrease in hydrogen feed can impair ammonia production.

Moreover, the various elements, portions, or sections of the low carbon ammonia production facility can exhibit different dynamic responses to variations in the availability of energy. For example, hydrogen production can be varied frequently and rapidly, e.g., within a few minutes or seconds. On the other hand, the ammonia synthesis loop needs longer time, e.g., several minutes or even hours, to respond to variations in the availability of energy and/or feed and reach new steady state operating conditions. Therefore, it is desirable to compensate for continuous and rapid energy availability and/or feed changes to ensure stable and reliable operations of the ammonia synthesis loop. In examples of the present disclosure, a buffer of hydrogen may be provided to balance the fast changes in the production of hydrogen from the primary hydrogen production source (e.g., an electrolyzer) with the slower changes in the consumption of hydrogen by the ammonia synthesis unit.

Thus, the design and operation of the entire low carbon ammonia production facility requires coordination of the front end energy production with the back end ammonia production when using low carbon energy sources operating an electrochemical system, such as an electrolyzer, to generate the hydrogen feed.

Disclosed herein is a system referred to as digital twin that includes a detailed and representative model that accurately reflects the structure and operation of a facility. In examples, a digital twin of the entire facility as described herein may be configured to analyze the differences in dynamics and response times between the front end and the back end and provide decision support capabilities, aiming to optimize the design and operation of the entire low carbon ammonia production plant.

As will become apparent, the present teachings facilitate the use of low carbon ammonia production by minimizing its levelized cost of production, ensuring that the technology is safe, and maximizing the operational stability of the synthesis loop.

In examples, a digital twin as described may be used in the design of the end-to-end low carbon ammonia production facility. The digital twin may be configured to take into account one or more of the variabilities in the low carbon energy available to the low carbon ammonia production facility, the specification of the equipment and the steady state and dynamic response of the processes of the low carbon ammonia production facility, and the availability of secondary energy and hydrogen sources external to the facility. In examples, the digital twin may be used to determine the combination of equipment configuration, equipment sizes and operating conditions that achieve the lowest levelized cost of ammonia production over the life cycle of the facility.

In examples, the digital twin as described may serve as a decision support tool for the design and operation of the low carbon ammonia production facility. Where multiple design options exist for the utilization of low carbon energy such as energy produced from wind and solar, the digital twin calculates the life cycle cost for each design option and identifies the design option that may show the lowest life cycle cost. The decision support with the digital twin may extend to the operation where the digital twin performs calculation to determine how the available low carbon energy may be utilized for producing ammonia, generating power for export or producing hydrogen into storage.

In examples, the digital twin as described may facilitate improvements in design, operation and maintenance of the low carbon ammonia production facility. The digital twin may be configured to use the model to analyze the availability of low carbon energy into the future and perform calculation to predict whether the operating conditions of the low carbon ammonia production facility may exceed the design and operation limits of equipment. Where the operating conditions are outside the limits, the digital twin may be configured to perform calculations to determine the changes required on the process and equipment specification that may minimize the occurrences of such conditions in the future.

In examples, the digital twin as described may provide solutions that allow the use of the low carbon energy sources for ammonia production by mitigating the impact of such reductions on the efficiency of ammonia production. In examples, the digital twin may provide solutions that allow a dynamic energy source, such as low carbon energy source, to supply energy to any process whose stability is affected by a dynamic energy supply.

In examples, a digital twin can be a digital representation of a low carbon ammonia production facility that is able to simulate the steady-state behaviour as well as the dynamic and transient behaviour of the low carbon ammonia facility. In certain aspects, the digital twin may be constructed to digitally represent one or more low carbon energy sources, one or more secondary energy sources, one or more hydrogen sources, and one or more nitrogen sources in addition to the ammonia loop.

The accompanying drawings and the following description provide example implementations with the understanding that the present disclosure is to be considered an exemplification of the principles of the disclosure and is not intended to limit the disclosure to that illustrated and described herein.

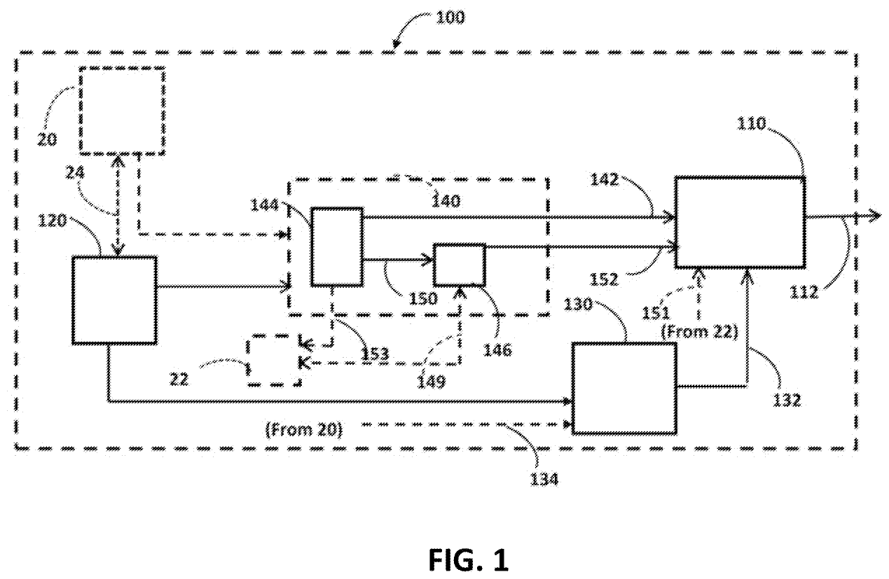

Referring to FIG. 1, there is schematically shown a non-limiting example of a low carbon ammonia production facility 100, that may be represented by a digital twin in accordance with the present disclosure. In an example, facility 100 includes an ammonia synthesis loop 110 configured to produce an ammonia product 112. To reduce or eliminate carbon emissions, a low carbon energy source 120 may be used to supply electrical energy to one or more elements, portions, or sections of facility 100. In examples, because the power output of the low carbon energy source 120 may fluctuate due to external influences, such as weather conditions, the supply of power from the low carbon energy source 120 may encounter prolonged interruptions or be subject to diminished capacity. With the benefit of the present teachings, such low carbon energy sources 120 may also be used to supply energy to facility 100.

The ammonia synthesis loop 110 may receive a nitrogen feed 132 from a nitrogen source 130 and a direct hydrogen feed 142 directly from a hydrogen source 144. The nitrogen source 130 may be a conventional air separator unit that may be powered by the low carbon energy source 120 and/or from a secondary energy source 20 (e.g., a power grid). In one non-limiting example, the secondary energy source 20 is operationally independent of facility 100. Such a secondary energy source 20 is not controlled by or dependent upon facility 100.

The hydrogen plant 140 generates the direct hydrogen feed 142 using a low carbon process. Electricity for the process may be supplied by the low carbon energy source 120. In one arrangement, the hydrogen plant 140 includes a hydrogen source 144 and a hydrogen storage unit 146. In one example, the primary hydrogen production source 144 may be an electrolyzer 144. The primary hydrogen production source 144 (e.g., an electrolyzer) generates a hydrogen feed that may include a direct hydrogen feed 142 to the ammonia synthesis loop 110 and/or a hydrogen feed 150 to the hydrogen storage unit 146. The direct hydrogen feed 142 and the hydrogen feed 150 are shown as separate merely for clarity. A common effluent line (not shown) from the primary hydrogen production source (e.g., an electrolyzer) 144 may be used to selectively direct flow to either or both of the ammonia synthesis loop 110 and hydrogen storage unit 146. It should be noted that the present teachings are not limited to a hydrogen plant 140 that uses only a primary hydrogen production source (e.g., an electrolyzer) 144 to generate the hydrogen feed. The present teachings are equally applicable to any system or method of generating hydrogen via a low carbon process that uses electricity.

The hydrogen storage unit 146 provides a supplemental hydrogen feed for the ammonia synthesis loop 110. In one arrangement, the hydrogen storage unit 146 stores hydrogen and supplies the stored hydrogen via hydrogen feed 152 to the ammonia synthesis loop 110, if needed. In some examples, the hydrogen storage unit 146 may be supplied by a secondary hydrogen source 22 via a secondary hydrogen feed line 149. In one example, a “secondary hydrogen source” is a hydrogen source that is operationally independent of facility 100. In such an example, the secondary hydrogen source has access to sources for receiving power and hydrogen that are independent of facility 100. In examples, a secondary hydrogen source 22 may import hydrogen into the facility, for example through a pipeline. Also, excess hydrogen from the primary hydrogen production source (e.g., an electrolyzer) 144 and/or the hydrogen storage unit 146 may be exported to the secondary hydrogen source 22 via lines 153 and 149, respectively, or different lines. The secondary hydrogen source 22 may also provide a supplemental hydrogen feed to the ammonia synthesis loop 110. For example, hydrogen can be supplied to the ammonia synthesis loop 110 directly from the secondary hydrogen source 22 via the direct secondary hydrogen feed 151. In examples, hydrogen feed to the ammonia synthesis loop 110 may be a combined feed of hydrogen from hydrogen storage unit 146 and secondary hydrogen source 22.

As noted above, in some examples, the secondary energy source 20 may include an electrical grid, which is an independent energy source and may provide or accept unlimited amount of energy at a cost. In such examples, surplus electricity generated by the low carbon energy source 120 may be fed into the electrical grid through energy connection 24. In other examples, the secondary energy source 20 may also include an electrical power storage device that is charged by the low carbon energy source 120 and/or the electrical grid through energy connection 24. Suitable electrical power storage devices include but are not limited to electrochemical batteries, capacitors, magnetic energy storage, etc. As noted above, a secondary hydrogen source 22 may be used in some situations. When present, the secondary hydrogen source 22 may provide a supplement hydrogen feed to the ammonia synthesis loop 110. This supplemental hydrogen feed may be in place of, or in addition to the hydrogen feed 152 from the hydrogen storage unit 146.

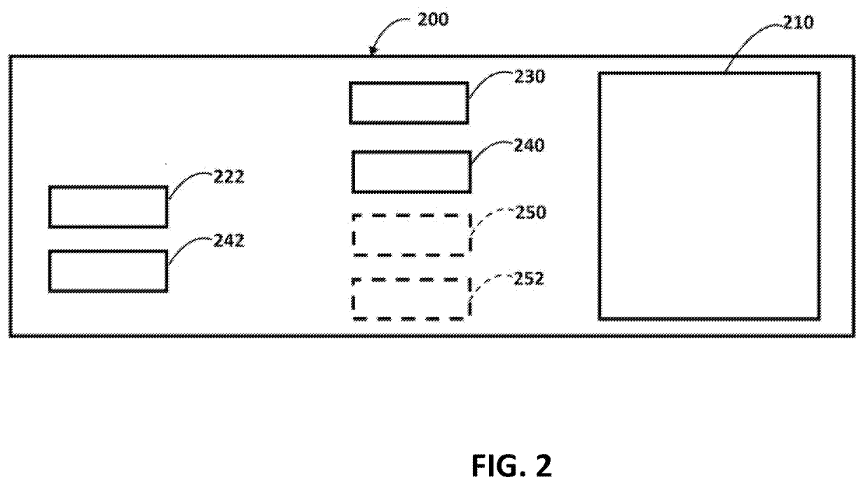

FIG. 2 illustrates a diagram of an example of a digital twin 200 for facility 100 schematically represented in FIG. 1. In examples, the digital twin 200 may be implemented using computer programming or engineering techniques including computer software, firmware, hardware or any combination or subset thereof. The digital twin for the low carbon ammonia facility may include of a collection of first principles equations which describe the physical and chemical phenomena, including the mass, heat and momentum transfer, occurring in the process and the interconnectivity of material and energy between the various physical units or equipment within facility 100, based on the physical facility design. The digital twin 200 may reside in a memory accessible by a conventional information processing device, such as a general-purpose computer. The person who may be running the digital twin and may be using the results to provide input during the design and/or operation of facility 100 is called a “user”. In examples, the system as described herein may include one or more user input devices such as a keyboard and mouse to allow a user to input information into the digital twin 200 and/or one or more user output devices such as one or more displays to output information to a user. The digital twin 200 may include computer code that models accurately elements, portions, or sections of facility 100 (FIG. 1). By “model accurately,” it is meant that one or more software components may be provided to include structures, equations, algorithms, computations, numerical values, graphics and relationships that are selected to predict the behavior, state, condition, or response of a physical elements, portions, or sections of facility 100 based on one or more inputs. For purposes of this disclosure the term “software component” or just “component” is used broadly to refer to a software package, a web service, a web resource, or a module that encapsulates a set of related functions or data. Also, the term is broadly intended to refer to a single software component or a group of multiple software components working together. In one example, the digital twin 200 may include an ammonia synthesis loop software component 210 (or “ammonia synthesis loop component 210”), a secondary energy source software component 222 (or “secondary energy source component 222”), a nitrogen source software component 230 (or “nitrogen source component 230”), a hydrogen source software component 240 (or “hydrogen source component 240”), and a secondary hydrogen source software component 242 (or “secondary hydrogen source component 242”). Other examples may include additional components 250, 252, which may embody or reflect the flowrate, energy consumption and performance information of equipment such as pumps, compressors, flow control devices, etc.

The ammonia synthesis loop component 210 may be constructed using algorithms, logic and mathematical relationships relating to the ammonia production process. In examples, the ammonia synthesis loop component 210 may be configured to simulate the ammonia synthesis loop of a facility. The process constraints and variables may include pressure ranges, temperature, and recycling efficiency. The ammonia synthesis loop component 210 may receive inputs, such as hydrogen flow rate and nitrogen flow rate and generate outputs, such as ammonia production flow rate and energy usage. During the design of low carbon ammonia production facility, inputs may be defined by the user. During the operation of low carbon ammonia production facility, inputs may be the actual measured values obtained from the facilities measurement systems or control systems.

The secondary energy source component 222 may be constructed using algorithms, logic and mathematical relationships relating to the electricity grid or a battery structure. The secondary energy source component 222 may consider the electricity availability, capacity and other limitations of all secondary energy sources available to facility 100.

The nitrogen source component 230 may be constructed using algorithms, logic and mathematical relationships relating to generating nitrogen. In examples, the nitrogen source component 230 may be configured to simulate the nitrogen source of a facility. In some examples, the nitrogen source component 230 may be based on the operating characteristics of a nitrogen producing facility. The nitrogen source component 230 may be configured to generate outputs, such as rate of nitrogen generation, power usage, etc.

The hydrogen source component 240, which may be configured to simulate the hydrogen source 140 and/or the hydrogen storage 146, may be constructed using algorithms, logic and mathematical relationships relating to generating hydrogen. In some examples, the hydrogen source component 240 may be based on the operating characteristics, such as production capacity, ramping rate and energy consumption of a primary hydrogen production source (e.g., an electrolyzer) and a hydrogen storage option. The hydrogen source component 240 may be configured to generate outputs such as rate of hydrogen generation, power usage, etc.

The secondary hydrogen source component 242 may be constructed using algorithms, logic and mathematical relationships relating to hydrogen supply from a secondary hydrogen source. In some examples, the secondary hydrogen source component 242 may represent a hydrogen source importing hydrogen into the low carbon ammonia facility, for example through a pipeline.

It should be appreciated that the digital twin 200 according to the present disclosure is not limited to the example illustrated in FIG. 2. For example, the hydrogen source component may be omitted and represented by data representing the energy usage and/or hydrogen feed production of the hydrogen source. In other examples, the ammonia synthesis loop may be omitted. In such an example, outputs of the digital twin may be used to evaluate or characterize the hydrogen and nitrogen feeds available for the ammonia synthesis loop. Thus, it is emphasized that one or more of the above-described components may be omitted from the digital twin 200 or represented using inputs, i.e., treated as a fixed value rather than a variable.

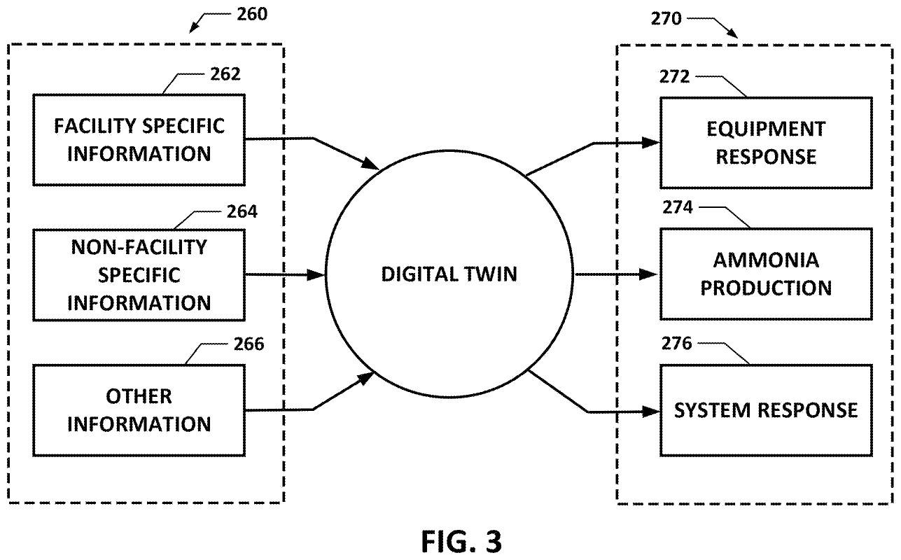

Referring to FIG. 3, there is functionally illustrated the digital twin 200 and exemplary inputs of information 260 and exemplary simulated facility outputs 270.

In examples, the digital twin 200 may receive information 260 over a period of time and/or at time intervals. In examples, the duration of a period of time over which information 260 is received may vary. In examples, it may be dynamically modified, it may be preset, and/or it may be overridden by a user. In examples, the duration of a period of time over which information 260 is received may vary depending on the type of information 260 and/or amount of information 260 received. The frequency and/or duration of the time intervals may be uniform or varying. In examples, the time intervals may reflect updates made to information 260. In examples, the time intervals may be preset, dynamically adjusted, or a combination thereof. In examples, the time intervals may be overridden by a user.

In examples, information 260 may include facility specific information 262, such as costs, design and configuration parameters for the various elements, portions, or sections and equipment making up facility 100 (FIG. 1), e.g., the primary hydrogen production source (e.g., an electrolyzer) 144, nitrogen source 130, hydrogen storage unit 146, ammonia synthesis loop 110 and/or other elements, portions, or sections associated with facility 100. In examples, facility specific information 262 may include operating parameters, such as pressure, temperature, flow rates, energy usage, etc.

In examples, information 260 may include non-facility-specific information 264 relating to external factors and/or conditions that affect the design and/or operation of facility 100. In examples, the non-facility-specific information 264 may include a forecasted energy availability profile for a low carbon energy source over a time period. In examples, the forecasted energy availability profile for the low carbon energy source may be provided by the operator of the low carbon energy source, for example the operator of the solar farm, wind farm, tidal power plant, geothermal power plant, hydroelectric power plant, nuclear power plant, or hydrogen pipeline. In examples, the energy availability from the secondary energy source may be provided by the operator of the secondary energy source.

In examples, the non-facility-specific information 264 may include information, such as energy usage by other connected energy consumers, energy availability through the secondary energy source 20 (FIG. 1), hydrogen availability through the secondary hydrogen source 22 (FIG. 1), economic factors such as cost and price of electricity available through the secondary energy source 20 (e.g. grid), etc.

In examples, information 260 may also include other information 266, which may depend on what other inputs or information may be available and/or what outputs are desired from the digital twin 200. Examples of other information 266 may include market prices of ammonia, operational and material costs, hydrogen and/or ammonia production targets, etc.

The digital twin may receive information 260 consisting of facility specific information 262 such as current operating conditions of the facility, non-facility specific information 264, such as low carbon energy forecast for a period of time, and other information 266, such as market price of ammonia at pre-defined time intervals. Once the digital twin receives information 260 at each time interval, the digital twin may be configured to run a series of iterative simulations. In examples, the iterative simulations may be run by varying the process conditions received by the digital twin as facility specific information or non-facility specific information. As previously described, the facility specific information and/or non-facility specific information may be defined by the user (e.g. step size, total number of calculations, constraints, etc.). In examples, through the iterative simulations, the digital twin may be configured to predict one or more operating conditions for each sub-process area of a facility from which the digital twin may select to achieve the best or desired conditions. For example, the digital twin may select conditions that result in the most energy efficient way to produce ammonia subject to constraints.

As shown in FIG. 3, in examples, the simulated facility outputs 270 may include simulated equipment response 272, simulated characteristics of ammonia production 274, and/or simulated system response 276. In examples, the simulated facility outputs 270 of the digital twin 200 may include an simulated equipment response 272 of one or more units of facility 100. Non-limiting examples of responses include electrical power consumption, hydrogen production or consumption, etc. In examples, simulated facility outputs 270 may include simulated characteristics of ammonia production 274 such as levelized cost of ammonia, production profile over a period of time, quantity, efficiency, etc. Still other examples of simulated facility outputs 270 may include simulated system response 276 such as overall energy usage, duration and severity of interruptions to ammonia production, etc.

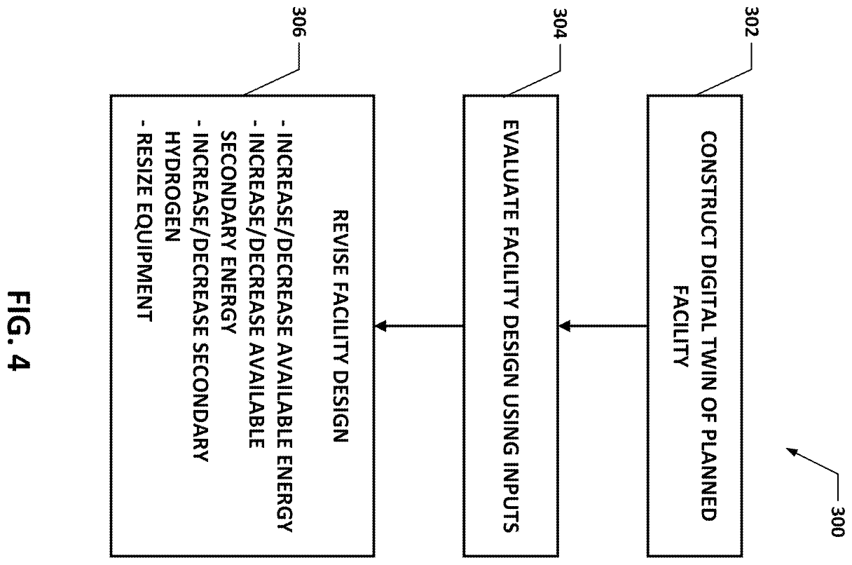

Referring to FIGS. 4-6, there are shown flow charts illustrating non-limiting example employments for the digital twin 200 of FIG. 2.

Referring to FIG. 4, there is shown a method 300 for using the digital twin 200 to configure and design a proposed facility for low carbon ammonia production.

At step 302, a digital twin of a proposed low carbon ammonia production facility may be constructed by compiling a combination of software components configured to represent the various portions of the facility. In examples, the employed software components representing the facility may be as described previously. In examples, the software components may be predesigned, allowing the digital twin designer to create a digital twin by selecting, linking, parametrizing and configuring one or more appropriate software components to reflect the various elements, portions, or sections of a facility. In examples, one or more software components may be created, linked parametrized and configured to reflect one or more elements, portions, or sections of a facility. In examples, creating a digital twin may include a combination of selecting, linking, parametrizing and configuring one or more predesigned software components and creating one or more software components.

At step 304, the digital twin 200 (FIG. 2) may be used to evaluate the proposed facility design using as input data information 260 (FIG. 3) consisting of facility specific information 262, non-facility specific information 264 and other information 266. The digital twin may receive as an input the energy availability profile of the low carbon energy source for a representative period of time specific to potential site conditions. The digital twin may also consider as an input the availability of power from the secondary energy source (grid or other sources). The digital twin may also receive as input information related to the hydrogen production as well as hydrogen availability from the secondary hydrogen source 22.

In examples, the digital twin may receive the following facility specific information 262, which may be adjusted based on site conditions:
capital cost factors, as well as maintenance and operational cost factors related to:
   generation of low carbon energy
   cost of energy
   production of low carbon hydrogen
   primary hydrogen storage
   primary energy storage unit
   production of low carbon nitrogen
   production of low carbon ammonia
expected life of facility 100
discount rate or weighted average cost of capital
production targets of each of the sections of facility 100

The digital twin may also receive non-facility specific information 264, such as the forecasted energy availability profile for the low carbon energy source for a period of time, as well as other information 266 as defined above.

After receiving information 260, in examples, the digital twin may be adjusted to run multiple configurations of the components to reflect the varying sizing for each of the element, portion, or section of facility 100 using one or more production or operational targets. In examples, the one or more targets may be predetermined as part of other information 266. In examples, a target may be a target cumulative production, a target fixed low carbon energy requirement, or other relevant target options as may be desired. The digital twin may be configured to calculate the levelized cost of producing ammonia and other relevant materials (e.g. hydrogen, nitrogen) as well as low carbon energy for each of the configurations. The digital twin may compare the levelized cost of producing ammonia and the other relevant costs to select the configuration resulting in the minimum levelized cost of ammonia (or other relevant products). The selected configuration may define the type of electrolyzer technology, the size of electrolyzer unit, the type and size of the primary hydrogen storage unit 146, the type and size of the primary energy storage, the type and capacity of the low carbon energy source (e.g. wind, solar, hydropower, etc.). It may also define the optimum ratio of the available low carbon energy sources to the required energy from the secondary energy source 20 (e.g. the grid). The digital twin may compare the levelized cost of producing ammonia and the other relevant costs calculated based on the availability and cost of hydrogen from the secondary hydrogen source.

At step 306, the simulated facility outputs 270 may be used to revise one or more aspects of the design of the facility. Such revisions may include, but are not limited to, increasing/decreasing the capacity of low carbon energy source 120, the capacity of secondary energy source 20, the capacity of the hydrogen primary source 144 and/or the size of the hydrogen storage unit 146, revising operating set points, adding/removing equipment, etc. It should be noted that revising the facility design may also include selecting a different geographical location.

It should be appreciated that examples of the digital twin 200 may be used to identify system configurations and operating parameters that can cope with predicted fluctuations of the low carbon energy availability by using the inventory of hydrogen in the hydrogen storage unit 146 and the available amount of hydrogen from the secondary hydrogen source 22, as well as the hydrogen which could be produced from energy available from the secondary energy source 20, to meet the hydrogen feed requirement for the ammonia synthesis loop 110. In examples, these calculations may be performed with the criterion to maintain the ammonia synthesis loop throughput as stable as possible. The digital twin 200 may be used to accurately predict hydrogen production and consumption during low carbon energy availability fluctuations using first principles calculation based on information 260 as input data. For example, during the period where the low carbon energy availability is low and cannot meet the hydrogen demand of the ammonia synthesis loop 110 at its design flow rate, the digital twin may make use of the hydrogen inventory in the hydrogen storage tank, the secondary hydrogen source or the secondary energy source, to maintain the operation and throughput of the ammonia synthesis loop as stable as possible. The digital twin may determine which option to use based on the relevant costs and availability limits of the various options. This determination may be performed at every time interval and for the entire duration of the available energy availability profile. In examples, this may allow the size of the hydrogen storage to be minimized in the design phase. That is, the hydrogen storage may not include capacity that may never be used. The first principles calculations may be repeated based on different sets of information 260 corresponding to different design options and may determine the size of the hydrogen storage required to accommodate the fluctuations in available energy from the low carbon energy source for each design option, as described earlier. In examples, the design option that shows the lowest hydrogen storage size may be obtained by comparing the simulated facility outputs 270 for all the design options evaluated and selecting the output reflecting the lowest hydrogen storage size. Thus, in examples, the digital twin 200 may be used to design an ammonia production facility that can use low carbon energy sources, given fluctuations in available energy from the low carbon energy source.

For example, constructing a relatively large hydrogen storage tank to provide a hydrogen buffer during energy interruptions may be perceived as enabling easier and more stable operation of the plant. However, the larger the hydrogen storage tank, the higher the investment and operating costs. In addition to the hydrogen storage, a low carbon ammonia plant may store electric power in expensive batteries or access a grid to be able to continue to operate when low carbon energy is not sufficient. Using the digital twin 200 it may be possible to allow hydrogen buffers and secondary energy sources to be sized, configured, and accessed to better manage energy interruptions.

From the above, it should be further appreciated that the present teachings can utilize the low carbon energy availability profile to determine how to efficiently operate a low carbon ammonia production facility by one or more of varying the hydrogen generation, managing the hydrogen inventory and managing the electricity storage. In examples, the digital twin as described herein may be configured to utilize a low carbon energy availability profile to determine the operation of the low carbon ammonia production facility by a combination of two or more of varying the hydrogen generation, managing the hydrogen inventory and the electricity storage, and adjusting the ammonia throughput accordingly. The low carbon energy availability profile as non-facility specific information 264 provided at each time interval may be used as an input to the first principles calculation embedded in the digital twin 200. The first principles calculation may first assume a constant ammonia throughput corresponding to the current conditions of facility 100 and determine simulated equipment response 272 and simulated system response 276 for each time interval for the entire duration of low carbon energy availability profile. The simulated system response 276 may then be compared to the relevant system response limits, which may be part of the facility-specific information 262. The equipment responses 272 may be compared to the equipment design limits, which may also be part of the facility-specific information 262. If an simulated equipment response 272 is within the equipment design limits and an simulated system response 276 is within the system response limits, the simulated facility output 270 of the digital twin 200 may define the current ammonia throughput as the simulated value of ammonia production 274 of the digital twin 200. If the simulated equipment response 272 is outside the equipment design limits or if the simulated system response 276 is outside the system response limits at any time interval, the first principles calculation may be configured to then vary the ammonia throughput target within the maximum and minimum design limit of the ammonia synthesis loop for each time interval and recalculate the simulated equipment response 272 and the simulated system response 276 until the simulated equipment response 272 meets the equipment design limits and the simulated system response 276 meets the system response limits for the entire duration of the low carbon energy availability profile. The newly calculated ammonia throughput target for each time interval may be provided as the simulated value of ammonia production 274. Thus, in examples, the present teachings can enable a facility operator to maintain stable, safe, and efficient operation of the ammonia synthesis loop. In examples, the digital twin solution for low carbon ammonia facilities, in coordination with the facility's control systems, may enable the automated operation of the facility, making possible continuous changes of the operating conditions that would pose a risk of undesirable facility responses if operated manually.

Thus, the digital twin 200 may be used to minimize the investment cost, maximize ammonia production, and/or optimize the use of low carbon energy and therefore may minimize the operating cost of such a low carbon ammonia production facility design.

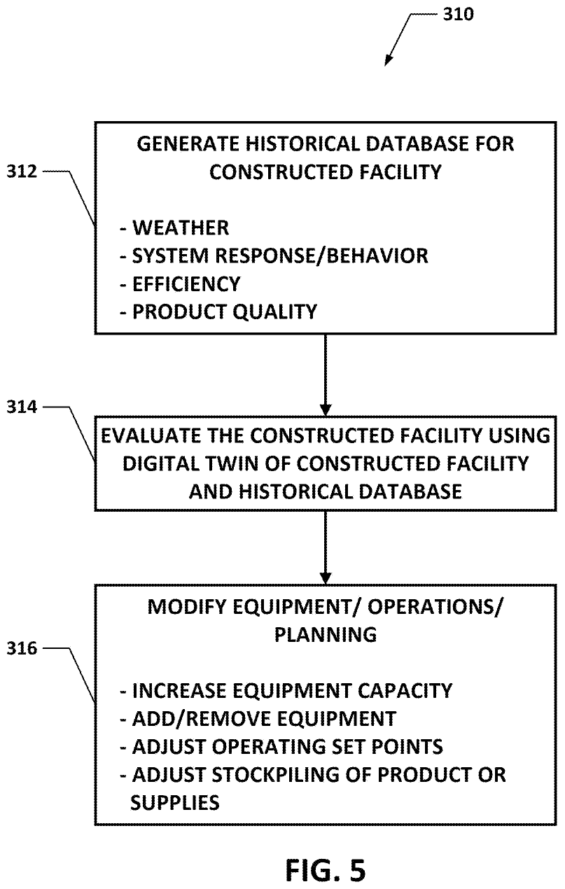

Referring to FIG. 5, there is shown a method 310 for using the digital twin 200 for evaluating and/or modifying the design and/or operation of an existing facility for low carbon ammonia production. At step 312, the various elements, portions, or sections of an existing low carbon ammonia production facility may be represented by one or more separate components forming a digital twin 200 as described previously.

At step 314, the digital twin 200 (FIG. 5) may be used to evaluate one or more aspects of the existing facility. This evaluation may start with gathering sets of current operating conditions and may include the comparison of the current operating performance of an equipment or of the entire facility 100 versus the expected design performance, the identification of the equipment constraints related to the performance of facility 100, and the prediction of the performance of an equipment or facility 100 using the first principles models to determine the alternative equipment size or design, following the same steps as described earlier. As previously stated, the digital twin may have embedded first principles models, empirical correlations, or data-driven models to accurately represent facility 100. These modeling or calculation methods may be utilized by the digital twin to estimate the directional as well as quantitative interactions between key operating parameters, such as production and energy, and the equipment performance and to ascertain whether the equipment operations is maintained between the corresponding constraint limits or not.

In examples, at step 316 (FIG. 5), the simulated facility outputs 270 (FIG. 3), obtained through the iterative execution of the digital twin (as described earlier), may be used to identify and/or implement possible revisions to the existing facility equipment, operations, and/or plan that may improve production efficiencies, reduce energy usage costs, improve service life, reduce maintenance activity, minimize down time, etc. Such revisions may include, but are not limited to, increasing/decreasing capacity for low carbon energy storage, hydrogen storage, revising operating set points, adding/removing equipment.

In examples, the digital twin 200 (FIG. 2) may be a hybrid composed of both proposed equipment and existing equipment. For example, the digital twin 200 (FIG. 2) may include components representing an existing carbon-emitting ammonia production facility and components representing a proposed low carbon energy source, hydrogen source, and nitrogen source. Thus, the digital twin 200 (FIG. 2) may be configured as needed to represent a particular proposed and/or existing ammonia production facility.

It should be appreciated that the present teachings provide digital twin solutions for low carbon ammonia plants. The digital twin solutions may be used to design a low carbon ammonia plant. In examples, this may lead to one or more of reduced investment cost, increased production of ammonia, more efficient use of low carbon energy, and reduced operating cost. In examples, the digital twin solutions of the present disclosure can be used to reduce the levelized cost of ammonia production.

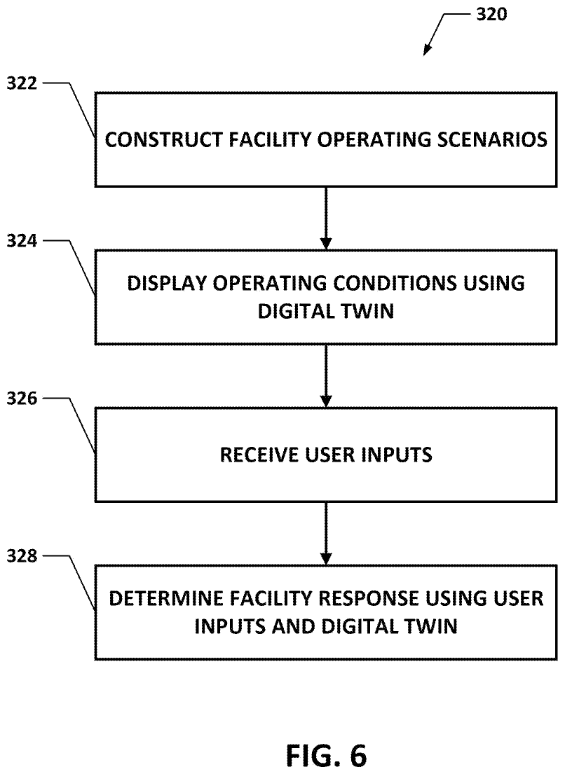

Referring to FIG. 6, there is shown a method 320 for training personnel to operate a low carbon ammonia production facility. Method 320 may use a digital twin 200 (FIG. 2) based on an existing facility, a proposed facility, or a combination of both. At step 322, one or more training scenarios may be constructed. Each training scenario may contain initial process conditions for the facility, as well as one or more sets of information 260 and may instruct the user to go through a series of steps to respond to these initial process conditions, aiming to maintain a safe, stable and further optimal operation of the facility, enhancing thusly the user's ability to operate one or more aspects of the actual facility. At step 324, the digital twin 200 (FIG. 2) may process the scenarios using an iterative calculation as previously described, and determine one or more operating parameters, process conditions, or other facility responses, which may be presented to the user through the user interface of the digital twin. At step 326, based on the scenarios generated through the execution of the digital twin, the user may enter changes to the operating setpoints of equipment or make changes to other operating conditions and/or process control setpoints of the facility. At step 328, the digital twin 200 (FIG. 2) may be used to generate outputs based on the user inputs and based on a calculation as previously described. These outputs may be used to evaluate the effectiveness of the user's inputs and thereby provide feedback to improve the user's ability to operate one or more aspects of the actual facility.

In examples, although not shown, one or more control systems may each independently include one or more controllers and/or other suitable computing devices may be employed to control one or more of portions of systems described herein. Controllers may include one or more processors and memory communicatively coupled with each other. In the illustrated example, a memory may be used to store logic instructions to operate and/or control and/or monitor the operation of one or more elements, portions, or sections of facility 100. In examples, the controllers may include or be coupled to input/output devices such as monitors, keyboards, speakers, microphones, computer mouse and the like. In examples, one or more controllers may also include one or more communication equipment such as transceivers or like structure to enable wired and/or wireless communication. In examples, this may allow for remote operation of one or more systems described herein.

Logic instructions may include one or more software modules and/or other sufficient information for autonomous operation, safety procedures, and routine maintenance processes. Any operation of the described system may be implemented in hardware, software, or a combination thereof. In the context of software, operations represent computer-executable instructions stored on one or more computer-readable storage media that, when executed by one or more processors, perform the recited operations. Generally, computer-executable instructions include routines, programs, objects, components, data structures, and the like that perform one or more functions or implement particular abstract data types.

Any such resulting program, having computer-readable code, may be embodied or provided within one or more non-transitory computer readable media, thereby making a computer program product, i.e., an article of manufacture, according to the discussed examples of the disclosure. In examples, memory associated with one or more controllers and/or other suitable computing devices may be non-transitory computer-readable media. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

In examples, the above-described systems and methods that can be configured to couple the operation of the ammonia synthesis loop with an intermittent source of energy. In aspects, the disclosed methods and systems can address the need for proactively managing the operation of the ammonia synthesis loop, given the intermittency and fluctuations of renewable wind and solar power, which may otherwise require having to frequently switch on and off the ammonia synthesis loop operation. In examples, the above-described systems and methods can reduce the technological risk associated with a green ammonia production plant, as well as reduce the risk of sub-optimal operation of a green ammonia production plant.

As used herein, the term “low carbon energy” refers to an energy source that does not use hydrocarbons as the principal source of energy. Examples of low carbon energy sources include, but are not limited to, solar power, wind power, tidal power, geothermal power, hydroelectric power, nuclear power, and any other low carbon chemical. It should be noted that the term “low carbon energy” source encompasses power sources that do not emit any carbon, i.e., “a zero carbon energy source.” Also, it is emphasized that terms such as “supplying power” or “supplying energy” does not require an uninterrupted supply or power having any specified minimum requirements.

The equipment, devices, components, and systems described above are only exemplary of the equipment, devices, components, and systems designed and configured to perform their respective tasks. For example, a primary hydrogen production source (e.g., an electrolyzer) is only one example of a device that may be used to generate hydrogen. Other hydrogen sources may utilize renewable liquid reforming, high-temperature water-splitting, photobiological water splitting, photoelectrochemical water splitting, etc. Thus, the present teachings are neither limited to the equipment, devices, components, and systems described above nor the processes used therein. Rather, the present teachings encompass any hydrogen generation technology, or mix of technologies, that can provide a hydrogen feed for the ammonia production loop.

The words “comprising” and “comprises” as used throughout the claims, are to be interpreted to mean “including but not limited to” and “includes but not limited to”, respectively.

To the extent used herein, the word “substantially” shall mean “being largely but not wholly that which is specified.”

As used herein, the singular forms “a,” “an,” and “the” are intended to include the plural forms as well, unless the context clearly indicates otherwise.

To the extent used herein, the term “about” in reference to a given parameter is inclusive of the stated value and has the meaning dictated by the context (e.g., it includes the degree of error associated with measurement of the given parameter).

To the extent used herein, the term “and/or” includes any and all combinations of one or more of the associated listed items.

The foregoing description is directed to particular examples of the present disclosure for the purpose of illustration and explanation. It will be apparent, however, to one skilled in the art that many modifications and changes to the example set forth above are possible without departing from the scope of the disclosure. It is intended that the following claims be interpreted to embrace all such modifications and changes.

What is claimed is:

1. A method of evaluating one or more aspects of a low carbon ammonia production facility, comprising:
providing a digital twin implemented on a computer system that comprises a processor and non-transitory memory running software stored in a non-transitory memory, the digital twin comprising:
a hydrogen source component;
a nitrogen source component; and
an ammonia synthesis loop component;
receiving by the digital twin at least one input comprising facility-specific information, non-facility specific information, or other information; and
simulating the low carbon ammonia production facility via the digital twin to generate at least one simulated facility output based on the at least one input.

2. The method of claim 1, wherein the low carbon ammonia production facility comprises a low carbon energy source and wherein the at least one input received by the digital twin comprises a forecasted energy availability profile for the low carbon energy source over a period of time.

3. The method of claim 1, the digital twin further comprising a secondary energy source component.

4. The method of claim 1, the digital twin further comprising a secondary hydrogen source component.

5. The method of claim 1, further comprising receiving additional inputs at time intervals, and iteratively simulating the low carbon ammonia production facility via the digital twin based on the additional inputs to obtain the at least one simulated facility output for each time interval.

6. The method of claim 5, further comprising:
receiving additional forecasted energy availability profiles for the low carbon energy source at sequential time intervals; and
iteratively simulating the low carbon ammonia production facility via the digital twin based on the additional forecasted energy availability profiles to obtain the at least one simulated facility output for each time interval.

7. The method of claim 1, wherein the at least one simulated facility output is obtained based on one or more predetermined targets.

8. The method of claim 7, wherein the one or more predetermined targets comprise a target cumulative production, target of stable operation of an ammonia synthesis loop that is part of the low carbon ammonia production facility, target of low carbon energy requirement, or any combination thereof.

9. A method of managing operation and/or design of a low carbon ammonia production facility, comprising:
providing a digital twin implemented on a computer system that comprises a processor and non-transitory memory running software stored in a non-transitory memory, the digital twin comprising:
a hydrogen source component;
a nitrogen source component; and
an ammonia synthesis loop component;
receiving by the digital twin an input comprising facility-specific information, non-facility specific information, or other information; and
simulating the low carbon ammonia production facility via the digital twin to generate at least one simulated facility output based on the at least one input.

10. The method of claim 9, further comprising revising a facility plant design, a design of one or more facility equipment, one or more operating conditions, an operational plan of the low carbon ammonia facility, or any combination thereof, based on the at least one simulated facility output.

11. The method of claim 9, wherein receiving by the digital twin an input comprises receiving an input from a user, and further comprising evaluating the user input based on the at least one simulated facility output.

12. The method of claim 9, further comprising receiving, by the digital twin, additional inputs at time intervals, and iteratively simulating the low carbon ammonia production facility via the digital twin based on the additional inputs to obtain the at least one simulated facility output for each time interval.

13. A method of a method for producing ammonia in a low carbon ammonia production facility having an ammonia synthesis loop, the method comprising:
supplying energy to the facility from a low carbon energy source;
providing a digital twin comprising one or more software components configured to simulate one or more elements or parts of the low carbon ammonia production facility;
receiving, by a digital twin, a forecasted energy availability profile for the low carbon energy source over a time period;
simulating, using a digital twin, an operation of the facility based on the forecasted energy availability profile for the low carbon energy source to generate one or more simulated facility outputs; and
defining, based on the one or more simulated facility outputs, one or more of a design and operational aspects of the low carbon ammonia production facility.

14. The method of claim 13, further comprising:
receiving, by the digital twin, additional forecasted energy availability profiles for the low carbon energy source at time intervals;
iteratively simulating the operation of the facility via the digital twin based on the additional forecasted energy availability profiles to generate one or more additional simulated facility outputs for each time interval; and
revising, based on the one or more additional simulated facility outputs, one or more of the design and operational aspects of the low carbon ammonia production facility at each time interval.

15. A computer program product comprising a non-transitory memory storing computer-executable code that, when executed by a processor, causes the processor to:
generate a digital twin of a low carbon ammonia production facility;
receive by the digital twin at least one input comprising facility-specific information, non-facility specific information, or other information; and
simulate a low carbon ammonia production facility via the digital twin to generate at least one simulated facility output based on the at least one input.

16. The computer program of claim 15, the digital twin comprising a hydrogen source component, a nitrogen source component, an ammonia synthesis loop component, or a combination thereof.

17. The computer program of claim 15, the digital twin further comprising a secondary energy source component, a secondary hydrogen source component, or both.

18. The computer program of claim 15, wherein the computer-executable code, when executed by a processor, further causes the processor to:
receive by the digital twin, additional inputs comprising facility-specific information, non-facility specific information, or other information at time intervals; and
iteratively simulate the low carbon ammonia production facility via the digital twin based on the additional inputs to obtain the at least one simulated facility output for each time interval.

19. The computer program of claim 18, wherein each input received by the digital twin comprises a forecasted energy availability profile for a low carbon energy source over a period of time.

20. The computer program of claim 15, wherein the at least one simulated facility output is obtained based on the at least one input and on one or more predetermined targets.
